(19) United States
(12) Patent Application Publication
(10) Pub. No.: US 2009/0051130 A1
(43) Pub. Date: Feb. 26, 2009

(54) SUSPENSION SYSTEM

(76) Inventor: Heinz-Peter Huth, Uberherrn (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/660,500

(22) PCT Filed: Aug. 11, 2005
(86) PCT No.: PCT/EP2005/008706

§ 371 Date: Oct. 27, 2008

(30) Foreign Application Priority Data
Aug. 21, 2004 (DE) 10 2004 040 636.7

(51) Int. Cl. B60G 17/04; B60G 17/015

(52) U.S. Cl. 280/5.514; 280/5.515

(57) ABSTRACT

The invention relates to a suspension system, especially for vehicles with changing load conditions. Said suspension system comprises at least one suspension cylinder (10, 12) comprising respective pressure compartments such as an annular compartment (14) and a piston compartment (16), a load-sensing system (18) for producing pressure, two supply lines, forming two main branches (22, 24), between said compartments (14, 16) and a pump connection (P) and a reservoir connection (T), one valve (26, 28) being connected in every main branch (22, 24), at least one valve (26) thereof being a pressure valve via which the pressure for the respective defined pressure compartment of the respective suspension cylinder (10, 12) can be adjusted, and a leveling device. The inventive system is characterized in that the pressure control valve (26) adjusts not only the pressure but also the leveling device. For this purpose, the pressure control valve (26) is electrically actuated by means of a control device.

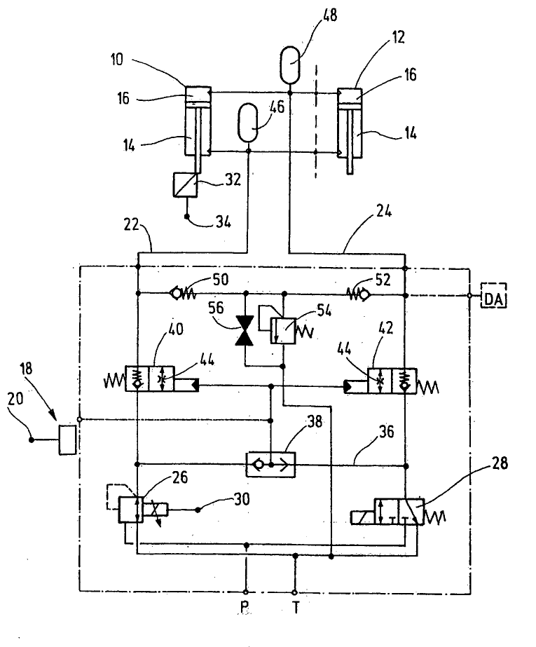

The invention relates to a suspension system, in particular for vehicles operating under varying load conditions, having
at least one suspension cylinder with pressure compartments such as an annular compartment and a piston compartment,
a load sensing system for pressure generation,
two supply lines forming main branches between these compartments and a pump and tank connection, there being introduced into each main branch a valve, at least one valve of which is a pressure control valve by which pressure adjustment is effected for the respective specified pressure compartment of the respective suspension cylinder, and
a level regulation device.

DE 42 42 448 C1 discloses a hydropneumatic suspension device relating to vehicles operating under heavy load conditions, in particular a device for tractors with means for mounting attachable equipment and load sensing pumps for pressure generation, the annular compartments of the suspension cylinders also being subjected to application of loads and being connected to a hydraulic accumulator. The object of the solution disclosed is to improve earlier configurations of this type having regulating mechanisms which must be fed by constant pressure systems, ones in which use of a load sensing pump is unsuccessful, since it would always have to operate in opposition to high pressure. This also has the result that the systems described constantly use energy. The solution disclosed accordingly proposes that, in order to conserve energy and thus create the possibility of using a load sensing pump, the annular compartment of the respective suspension cylinder be provided with pressure by way of a three-way pressure control valve, and that a level regulation device with a valve device be provided, one which is regulated up or down for brief periods only in the event of static load changes and in the rest position otherwise assumed removes pressure from all control lines and feed lines, the piston and annular compartments being hermetically sealed by way of openable return valves. Application of the disclosed solution requires that the pressure control valve be hydraulically controlled. In addition, for the purpose of level regulation the pressure in the annular compartments of the suspension cylinders is adjusted on the basis of their pressure relationships on the piston side, for which purpose conventional switching valves are employed.

The disclosed solution accordingly requires for pressure adjustment and level regulation that additional switching valves be employed in addition to the hydraulically controllable pressure control valve, so that, in effect, pressure adjustment on the annular compartment side of the suspension cylinders and level regulation be functionally separated. In addition, the possibilities of adjusting the pressure of the suspension cylinders to various pressure levels in order to show different suspension characteristics is limited.

A comparable solution, but one not involving use of proportional pressure control valves, is also disclosed in WO 03/006270 A1.

On the basis of this state of the art the object of the invention is to create a suspension system which, while retaining the advantages of the disclosed solutions, is further improved to the end that a configuration with fewer valves be made possible, one which creates the possibility of variable adjustment of the operating pressure on the annular side of the respective suspension cylinder in order to obtain variable suspension characteristics. An object as thus formulated is attained by a suspension system having the characteristics specified in claim 1.

In that, as specified in the characterizing part of claim 1, level regulation in addition to pressure adjustment is accomplished by means of this pressure control valve, and in that for this purpose the pressure control valve may be electrically actuated by means of a control system, it is possible to use the proportional pressure control valve for pressure adjustment on the annular side and at the same time for level regulation. It accordingly is not necessary, as it is in the state of the art, to use additional switching valves for level regulation itself, so that the solution claimed for the invention reduces the manufacturing cost. In view of the fact that some switching valves are not used, maintenance costs and potential error sources are reduced. In addition, the solution claimed for the invention makes it possible to set the pressure on the annular side at different levels, so that varying suspension characteristics may be produced.

It is assumed in this discussion that the load on the piston side and the wheel sets with axles are mounted on the rod side of the respective suspension cylinder. The pressure on the piston side accordingly is determined by the load and the pressure in the annular compartment. The position of the proportional pressure control valve, which may also be a proportional pressure reduction valve, is not bound to the rod side of the suspension cylinder but rather the position is determined by the pressure compartment, which is not subjected to the load directly. Hence the solution claimed for the invention could also be comparably applied to an inverse suspension structure, one in which the load is positioned on the rod side and the wheels on the piston side.

In a preferred embodiment of the suspension system claimed for the invention, however, adjustment of pressure for level regulation is effected exclusively on the respective annular side of the suspension cylinder.

Other advantageous embodiments of the suspension system claimed for the invention are specified in the dependent claims.

The suspension system claimed for the invention will be described in detail in what follows on the basis of an exemplary embodiment illustrated in the single drawing, which shows the suspension system with its essential components in outline in the form of a switching diagram (hydraulic diagram).

The suspension system claimed for the invention is especially well suited for use in vehicles, the chief applications applying to heavy-load vehicles such as tractors, trucks, or the like. The suspension system shown in the FIGURE has two suspension cylinders 10, 12, each having pressure compartments such as an annular compartment 14 and piston compartment 16. When the embodiment is built the load rests on the piston side, that is, on the piston side of the piston compartment 16 of the respective suspension cylinder 10, 12, while the wheels and axles are mounted on the rod side of the suspension cylinder 10, 12, that is, facing the annular compartment side 14. In addition, the device is provided with a load sensing system identified as 18 as a whole, one which performs the function of pressure generation and is reproduced only symbolically and has a control station identified as 20 in the FIGURE. By means of the respective control station 20 the load sensing system is connected to a control device not shown, such as one in the form of a computer with corresponding data logic.

As is also to be seen in the FIGURE, two supply lines forming main branches 22, 24 are present between the compartments 14, 16 referred to, as well as a pump connection P and tank connection T. A valve 26, 28 is introduced into each main branch 22, 24 at least one 26 of which is a pressure control valve, in particular one in the form of a proportional pressure control valve or pressure control reduction valve. The pressure of the respective specified compartment of the suspension cylinders 10, 12 may be adjusted by way of the respective proportional pressure control valve 26. The basic configuration of the suspension system illustrated makes it possible to effect level regulation as well as pressure regulation for the suspension cylinders 10, 12, this being done in accordance with the invention exclusively by way of the pressure control valve 26. For this purpose the pressure control valve 26 may be actuated electrically by means of the control device already referred to and for this purpose has a connection point 30.

Pressure adjustment for the respective specified pressure compartment 14, 16 is effected preferably for the one which is not subjected directly to a load. Consequently, in the present exemplary embodiment pressure adjustment for level regulation is made exclusively on the respective annular side (annular compartment 14) of the suspension cylinder 10, 12. As is also to be seen in the FIGURE, at least the suspension cylinder 10 has a path measurement system 32 of conventional design, one which also has a connection station 34 for the purpose of delivering measurement data to the control device (not shown in detail). In particular, the data of the path measurement system 32 are processed by the control device for the load sensing system 18, which has a regulating pump (not shown) for generation of pressure for the suspension system, which is connected to the pump connection P.

A switching valve of conventional configuration, in particular one in the form of a 3/2-way valve 28, is connected to the other main branch 24. In addition, an alternating valve 38, an alternating ball valve in particular, is introduced between the two suspension cylinders 10, 12 and the associated valves 26, 28 into a secondary branch 36, which connects the two main branches 22, 24. The alternating valve 38 in turn is connected on the output side to the load sensing system and acts on two openable return valves 40, 42, which as actuatable 2/2-way valves are provided in their passage position with a choke.

In addition, in the case of the embodiment shown in the illustration a pressure absorber DA is mounted in the main branch 24 which leads to the piston compartment 16 of the respective suspension cylinder 10, 12. The piston compartments 16 and the annular compartments 14 of the respective suspension cylinder 10, 12, which are also connected together and which separately from each carry fluid, a hydraulic accumulator 46, 48 being engaged in the connection in question. A pressure limiting valve 54 which is connected to the tank connection T is introduced between the two main branches 22, 24 and protected by two return valves 50, 52.

Now that the basic hydraulic switching structure of the suspension system has been explained, the function of this system will now be discussed in greater detail on the basis of a working example. The suspension is configure by way of the size of the hydraulic accumulators 46, 48 and the size of the suspension cylinders 10, 12. In this configuration a specific suspension characteristic curve is plotted for each axle load and, if a different adjustment is made of the pressure on the annular side for the same axial load in the annular compartments 14 of the two suspension cylinders 10, 12, another suspension characteristic curve is obtained. This creates the possibility of making the ride hard or soft under the same axle load for a vehicle (not shown), for example, in order to make the ride somewhat harder on a street in order to increase driving safety or somewhat softer in off-road travel, in order to provide increased comfort for the operator.

Because of the electrically operable-pressure control valve 26 employed the possibility exists of adjusting the pressure for the suspension cylinders 10, 12 on the annular side on the basis of the relationships on the piston side. This is not possible with disclosed solutions because of the possibility of hydraulic actuation of the pressure control valve.

In order to make appreciable level regulation possible, the respective suspension cylinder 10, 12 with its piston rod unit should always be positioned in the central area in order in this way to have the complete suspension engagement and disengagement path in both directions available. The control device has the intelligence to detect respective deviations, by way of the data provided by the path measurement system 32. If, for example, the axle load for the suspension cylinders 10, 12 increases, the cylinders move correspondingly inward and, to work against this movement a fluid, a hydraulic medium (oil) in particular, must be introduced into the respective piston compartment 16 of the suspension cylinders 10, 12. For this purpose the valve 26 is actuated by the pressure required and at the same time the 3/2-way switching valve 28 is engaged. Thus operation of the alternating valve 38 becomes possible and pressure is then delivered to the load sensing system 28. The load pressure in the connection between valve 28 and valve 38 corresponds to the pressure on the piston side for the suspension cylinder 10, 12.

The adjustment pressure of the pressure valve 26 is present on the opposite side of the alternating valve 38 and the alternating valve 38 is adjusted with respect to the pressure difference in such a way that the highest load pressure is delivered by way of the load sensing system 28 to the regulating pump (not shown), which then goes to the regulating pressure. Since the required pressure is now present at the pump connection P, the related volume stream is sent by way of the 3/2-way valve 28 to the piston side of the suspension cylinder 10, 12. This situation continues until the control electronics or control device recognizes that the piston rod unit of the suspension cylinders 10, 12 has returned to the central position, with the result that the two valves 26, 28 are rendered free of current and the suspension system is adjusted specifically to a center position for the suspension cylinders 10, 12.

In the reverse case the load on the suspension cylinders 10, 12 is reduced, with the result that these cylinders move out and oil is drained from the respective piston compartment 16 and the respective hydraulic accumulator 48. In the state of the art this process customarily occurs by way of additional switching valves. In the solution claimed for the invention the respective drainage process also is conducted by way of the pressure control valve 26. If the control device (electronic) makes the decision, on the basis of the sensor position, that oil or hydraulic medium is to be discharged from the suspension cylinders 10, 12, valve 26 is again actuated and is set for the operating pressure which is to prevail on the annular side for the annular compartments 14. However, precisely this pressure signal is used in order to actuate the 2/2-way valve, and the choke 44, which may also consist of a diaphragm or nozzle, is engaged. Oil is drained as desired on the piston side until the position is reached again and the valve 26 may go back to its neutral or off position. The pressure control 26 thus makes it possible to drain hydraulic medium from the piston compartments 16 for the purpose of level regulation, and in the process the required pressure may be set simultaneously in the associated annular compartment 14. Dynamic pressure actuation is achieved in this manner, in which process the opposite pressures between annular compartment 14 and piston compartment 16 may be adjusted as desired on the basis of the load, so that in any event undesired pressure surges or pulsations are prevented.

The solution claimed for the invention also makes it possible to vary the pressure on the annular side for the suspension cylinders 10, 12 in order to obtain a different suspension characteristic, the possibility also existing of assigning a specific value for the suspension characteristics in advance, on the basis of the configuration between operating limits. In a stationary configuration serving this purpose use of a pressure absorber DA in the main branch 24 is not absolutely necessary. However, the optional h provided pressure absorber DA makes it possible for the control device (electronic) also to detect the pressure on the piston side and on this basis can Aintelligently@ adjust the pressure on the annular side by way the valve 26, that is, for example, provide a configuration strategy such that a constant suspension quality is guaranteed over the entire axial load range, one in which the pressure on the annular side is permanently adapted. The widest range of optional adjustments of permanent interrogation of the pressure absorber DA are provided, even with respect to uniform or prescribed suspension engagement frequency.

Protection of the piston compartment 16 may be achieved for the two suspension cylinders 10, 12 by means of the two return valves 50, 52 and by means of the pressure control valve 54. Such protection is necessary because the pressure in the piston compartment 16 depends on the pressure in the annular compartment 14 and any unknown load. In addition, the pressure in the annular compartment 14 may be protected by a system pressure protection system (not shown) in the pressure line and by the pressure control valve 26 (with secondary pressure restriction). The alternating valve 38 and the two 2/2-way valves 40, 42 make certain that the pressure control valve 26—even one with secondary pressure restriction—is always actuated during level regulation processes. The ball valve identified as 56 serves the purpose of pressure relief of the system during maintenance operations.

The suspension system as described and claimed for the invention may also be configured with only one suspension cylinder, in this instance suspension cylinder (10). All that is required for this purpose is omission of one suspension cylinder, in this instance suspension cylinder (12), for example by separation of this cylinder from the suspension system along the broken line, and the corresponding fluid lines could be closed off by sealing components such as blind plugs or the like. The suspension system shown in the FIGURE may also be used for more than two suspension cylinders, by means of appropriate wiring (not shown).

1. A suspension system, in particular for vehicles with varying load relationships, having
at least one suspension cylinder (10, 12) having pressure compartments such as an annular compartment (14) and a piston compartment (16),
a load sensing system (18) for pressure generation,
two supply lines between these compartments (14, 16) forming two main branches (22, 24) and a pump (P) and a tank (T) connection, there being introduced into each main branch (22, 24) a valve (26, 28) at least one valve (26) of which is a pressure control valve by way of which pressure adjustment is effected for the respective specified pressure compartment of the respective suspension cylinder (10, 12), and
a level regulation system,
characterized in that
in addition to the pressure adjustment, level regulation is effected by means of this pressure control valve (26), and
for this purpose the pressure control valve (26) may be actuated electrically by means of a control device.

2. The suspension system as specified in claim 1, wherein pressure adjustment is effected for the respective specified pressure compartment (14, 16) which is not subjected directly to the load, by preference pressure adjustment for level regulation being effected exclusively on the respective annular side of the respective suspension cylinder (10, 12).

3. The suspension system as specified in claim 1, wherein at least one of the suspension cylinders (10) has a path measurement system which forwards its data to the control device (32) which acts on the valves (26, 28).

4. The suspension system as specified in claim 1, wherein the other valve in the other main branch (24) is a switching valve, in particular a 3/2-way valve (28).

5. The suspension system as specified in claim 1, wherein an alternating valve (38) is introduced between two suspension cylinders (10, 12) and the associated valves in a secondary branch which joins the two main branches (22, 24) to each other.

6. The suspension system as specified in claim 5, wherein the alternating valve (38) acts on the output side on actuation of two openable return valves (40, 42) each of which is introduced into a main branch (22, 24).

7. The suspension system as specified in claim 6, wherein a throttle (44) is introduced into the respective main branch (22, 24) and is a component of the respective openable return valves (40, 42) and is configured as a 2/2-way valve.

8. The suspension system as specified in claim 4, wherein the alternating valve (28) is connected on the output side to the load sensing system (18).

9. The suspension system as specified in claim 1, wherein a pressure absorber (DA) is mounted in the main branch (24) which leads to the piston compartment (16) of the respective suspension cylinder (10, 12).

10. The suspension system as specified in claim 1, wherein the piston compartments (16) and the annular compartments (14) of the respective suspension cylinders (10, 12) are connected to each other while conducting fluid separately from each other, and wherein a hydraulic accumulator (46, 48) is introduced into each of the connections.

11. The suspension system as specified in claim 1, wherein a pressure restriction valve (54) which is connected to the tank connection (T) and is protected by return valves (50, 52) is introduced between the two main branches (22, 24).
